(19) United States
(12) Patent Application Publication
(10) Pub. No.: US 2001/0032245 A1
(43) Pub. Date: Oct. 18, 2001

(54) Industrial capacity clustered mail server system and method

(76) Inventor: Nicolas Fodor, Miami, FL (US)

Correspondence Address: Anthony R. Barkume, Esq.,, Greenberg Traurig, LLP,, 200 Park Avenue,, New York, NY, 10166, US

(21) Appl. No.: 09/746,952

(22) Filed: Dec. 22, 2000

Related U.S. Application Data
(60) Provisional application No. 60/171,425, filed on Dec. 22, 1999.

(51) Int. Cl. G06F 15/16

(52) U.S. Cl. 709/206; 709/229

(57) ABSTRACT

A method and system for load balancing at a domain name server and Internet mail server for mail messages where the system is modified to direct mail via sequentially selected mail servers comprises a networked dynamic domain name server computer communicating with a plurality of email servers (SMTP listeners), POP servers and a plurality of email clients.

### CROSS REFERENCE TO RELATED U.S. APPLICATIONS

This application claims priority under 35 U.S.C. §119(e) from U.S. Provisional Application No. 60/171,425, filed Dec. 22, 1999, by Nicholas Fodor, which is incorporated herein by reference in its entirety.

### FIELD OF THE INVENTION

The present system generally relates to high capacity Internet electronic mail handling processes to assure distributed load balancing and a high level of redundancy.

### BACKGROUND OF THE INVENTION

There are different classes of third party providers of email services that support a distributed user base. For example, web site portals such as Yahoo and Hotmail provide email services to the subscribers at their sites. The global availability and the popularity of these services as well as new upcoming services has generated a need in industry to provide mission critical, around the clock service, to a high numbers of users.

At the domain name server (“DNS”) level, a company such as a small business or a large multinational organization registers a domain name with a DNS. Part of the registration and configuration information provided to the DNS system is the primary domain server and secondary domain server that are managed by that company or a third party Internet Service Provider (ISP). Information related to specific hosts and services related to a domain is stored in the DNS server as “records”. A special type of record specifically adapted for email handling is called a mail exchange (“MX”) record. A table of MX records (“DNS tables”) for an Internet domain are established in the DNS indicating the domain name and address for the one or more servers on the IP network that function as an email host. An email host receives all the mail for one or many domains. The DNS MX records define which mail servers on the Internet are authorized to store and forward incoming email for a given domain.

The MX record additionally includes a preference indicator provided by the network administrator. The preference indicator, also referred to as a priority index, prioritizes which server will be contacted first to service an incoming email. Typically, the preference indicator is a number in which a lower number indicates a higher priority. Mail servers for an Internet domain receive email from other mail servers on the Internet which are relay servers of the other domains. Relay servers must route emails to the proper mail server for the domain to which the recipient belongs. To accomplish this routing, relay servers query the DNS of the destination domain. When a DNS receives a request for mail server information for a domain, it looks at the MX records. There can be multiple MX records in a DNS for a given domain. Existing DNS work by providing relay servers with all of the mail hosts registered in the MX records for the destination domain. A relay server first tries to connect to the host indicated by the MX record with the lowest priority index. If they fail, they will try to connect to the host indicated by the MX record with the next higher level of priority. This process continues until a host is successfully reached by the relay server or until no host is reached and there are no more MX records for the destination domain.

One problem with this method of managing email is that the relay mail server for the recipient's domain always attempts to deliver mail to the highest preference mail server, while the secondary servers are used strictly in the events of an over-capacity condition or a complete failure of the primary domain server. Even though the DNS allows the remitting relay server to fail over to a second mail server, in case the first one does not respond, due to, for example, overcapacity, it does not allow balancing the incoming mail load on multiple servers, or if it allows balancing, it cannot handle equal mail availability or later retrieval on any of the balanced servers. Thus, MX records allow for failover but not for load balancing.

Another problem with present email management systems is scalability. In the current systems, the primary and secondary email servers typically share a storage servers on which mail messages are stored. Once this system has reached capacity, new storage servers or mail servers cannot be added without bringing down the whole system. For clients of the system, that means not only being cutoff from one's email, but not being able to receive email at all while the mail management system is down. Furthermore, such systems are not fault tolerant. If the storage server fails, all messages stored therein can be lost.

Thus, there is a need fro a mail management system that provides for load balancing for both the mail servers and storage servers, is scalable in response to new usage demands, and is fault tolerant in response to system component failures.

### SUMMARY OF THE INVENTION

The present invention is a system and method for managing mail messages where the mail processing and storage is distributed between multiple mail servers for a domain, rather than sending mail messages to one primary email server until an over-capacity problem exists. This shifts the load from the first mail server to the second and third mail server, etc., as messages are processed. The manner by which the process and storage distribution is accomplished can be, for example, sequential, random, based on load queries of the mail and storage servers by the DNS, or based on an analysis of the size of a message needing processing. The scope of the present invention is not limited to these methods of distribution, however, and other method of load distribution are, of course possible.

The objective of the design presented is to provide a system where the domain name server performs additional functions to select the preferred mail server for accepting incoming email such that mail is handled as rapidly as it is received and additionally supports an enhanced method of distribution of replicated mail such that failure on one or more mail servers will not effect the ability to instantaneously retrieve or rebuild a client's mailbox.

### BRIEF DESCRIPTION OF THE DRAWINGS

FIG. 1 is a representation of the system components of the present invention;

FIG. 2 is a process diagram of the email storage process of the present invention;

FIG. 3 a representation of the system components of the email retrieval process of the present invention;

FIG. 4 is a process diagram of the method of retrieving email of the present invention;

FIG. 5 is a view of the mirroring table of the present invention;

FIG. 6 is a view of the catalog table of the present invention;

FIG. 7 is representation of message reception and retrieval process of the present invention.

### DETAILED DESCRIPTION OF THE PREFERRED EMBODIMENT

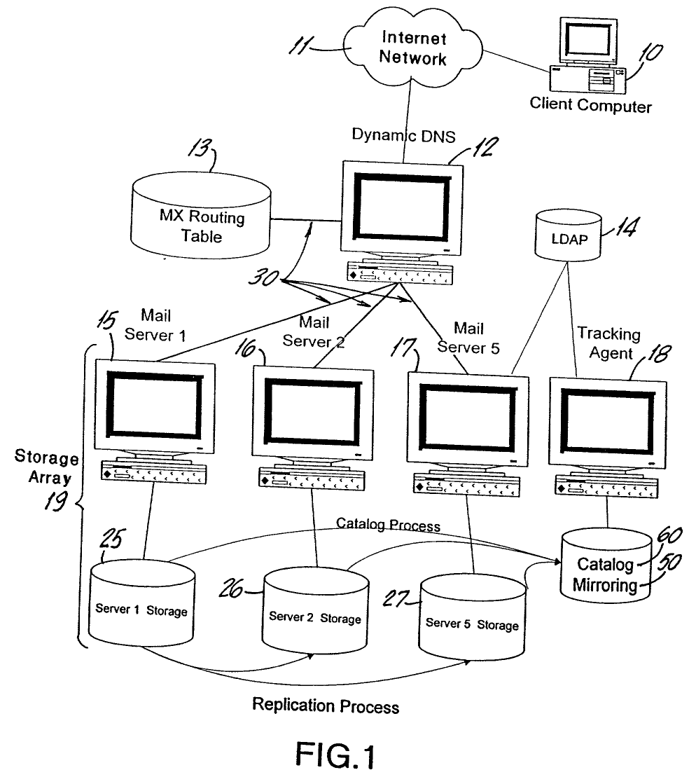

A diagram of a mail hosting system of the present invention for large numbers of mailboxes is presented in FIG. 1. The system of the invention comprises a DNS 12 with routing tables 13 in networked communication with a plurality of simple mail transfer protocol (“SMTP”) listeners/servers 15, 16, 17, with dedicated storage servers 25, 26, 27, linked with high speed access via local bus 30. An email client 10 is connected to DNS 12 via an Internet connection 11. The mail hosting system also includes database of local mailboxes 14, such as a lightweight directory access protocol (“LDAP”) compliant directory, a database or a flat file, a message tracking agent 18, whose function is explained below, a tracking catalog 60 and a mirroring table 50. The tracking catalog 60, which can be a database or a flat file, is used to record messages as they are stored in the storage servers 25, 26, 27, while the mirroring table 50, which can also be a database or flat file, supports the mirroring function of the invention. Although these two tables are depicted as being stored on the same storage device, the invention is not limited to this embodiment, and the tables can be stored on any device within the hosting system of the invention.

The mail servers 15, 16, 17, and storage servers 25, 26, 27 are deployable in an array configuration 19 allowing direct interaction between each other for the purpose of mirroring and scalability. This system 19 of listeners and storage devices is referred to as a storage array. Mirroring refers to the process by which the system makes one or more duplicate copies of an incoming message and stores these copies on other devices within the storage array. The DNS 12 cycles through the available mail servers indexing to a different server for each message or group of messages in order to distribute loads. In one preferred embodiment, the DNS 12 selects the mail servers in a roundtable order, in which servers are selected sequentially with a first server being selected after a last server. Alternatively, the DNS 12 can query the mail servers in the array as to their current load, and can dynamically alter the preference indicator value of a server in response to a server's load. In a further alternative embodiment, the DNS can select a mail server based on analyzing an incoming message's content. For example, an incoming message labeled as urgent can be routed to a server with a fats access time. The ability of the DNS to dynamically select preferred mail servers is a distinguishing feature of the DNS of the present invention, and for this reason, this DNS is referred to herein as a dynamic DNS. Although only three mail servers and storage servers are depicted in FIG. 1, the invention is in no way limited to a storage array of three mail servers and storage servers, and any number of mail and storage servers can be included in the storage array.

In a preferred embodiment, the SMTP listeners 15, 16, 17, are mid-range servers (no particular brand is required) each having their own central processing unit (“CPU”) running the Windows NT Operating System. Alternatively, the servers can be configured to run the Unix operating system. Access server software, such as software supporting the point-of-presence (“POP”) protocol, is configured to execute on either one or more of the SMTP servers, on the dynamic DNS, or on a standalone server to provide access to a client's 10 email messages based upon requests received from the email client 10. Alternatively, the Internet Messaging Access Protocol (“IMAP”) can be used to provide clients access to their email.

While the system of the present invention receives mail from an external DNS in the same manner as previous mail management systems, there is a significant difference in the manner that the mail message is catalogued, stored and replicated to support high levels of traffic. Furthermore, when an email client requests his or her mail, the present invention generates the client's mailbox content in a highly distributed and redundantly available manner, even though the request for content appears to return to the client the same content as available from other mail management systems.

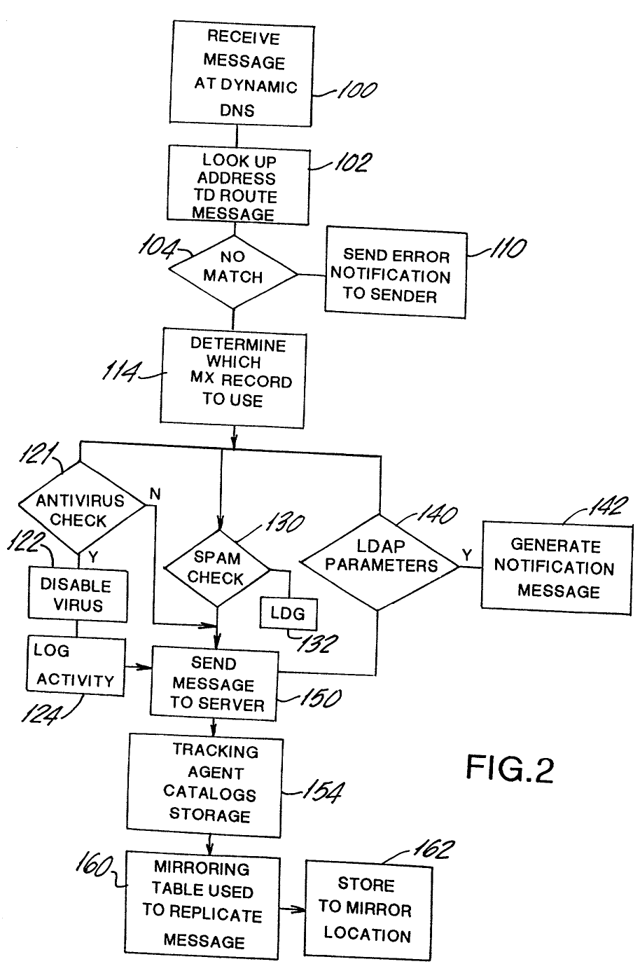

Referring now to FIG. 2, the process commences with incoming external email traffic that is received at a company's dynamic DNS at step 100. The first step is to query the DNS tables 13 to determine whether the designated recipient of the message is recognized by the system. This will preferably be accomplished by reference the routing tables 13 of the MX records identifying the path to the designated SMTP listener associated with the corresponding MX record. By having a table of SMTP listeners associated with specific MX records, the load balancing aspects of the present system can be accomplished. In addition, the preference indicator in the MX record for each SMTP listener can be altered by the DNS 12 in response to the load for that listener. The servers referenced in the MX records do not necessarily need to be on the same part of the network or have the same domain name. Messages may be routed through the Internet to these other referenced mail servers via routers.

If, at step 104, the message received is identified as having a recognized recipient domain, the second step is to then route, at step 114, to the server (SMTP listener) associated with the MX record in question. If the specified domain was not recognized, the DNS will respond at step 110 with an error message “no valid recipient on specified domain”. These SMTP listeners will be configured to receive traffic on a preferred port, thereby blocking all other unrelated traffic.

Now, at step 118, several operations are performed prior to the message being sent to the corresponding SMTP listener in order to have the message properly analyzed so as to identify any attributes that would restrict its distribution to servers of the present system. First, the message content is scanned with an antivirus software utility at step 121. If a virus is found and the system can disable the virus, the virus contents are disabled at step 122, otherwise the infected message is held in a separate queue for more detailed analysis. The virus activity is logged at step 124. Second, the originator of the message is extracted from the message header and is queried against a “SPAM” database at step 130 to see if the originating domain has been tagged for filtration. If the message is flagged as such it is logged at step 132. Third, the recipient of the message is queried at step 140 against the database of local mailboxes 14 to see if the particular client has chosen the option to receive short message service (“SMS”) notification of the inbound message. If true, the system will generate and send out the SMS message at step 142 alerting the client of a new message pending retrieval. If the preceding analysis does not report any problems with the message then the message may be then be sent to the mail server to be properly catalogued and committed to storage. Note that the three operations described above are illustrative, and more or fewer operations can be performed on the incoming message, depending upon the embodiment.

When the message is sent to the mail server as determined by the dynamic DNS at step 150, the message transaction is recorded by the message tracking agent 18 at step 154 in the tracking catalog 60, which is preferably cached for fast query. A simplified tracking catalog table is shown in FIG. 6. The actual tracking catalog table includes comprehensive tracking information used to refer back to the stored message location. The message tracking agent 18 is especially significant in its functionality since it maps the entire storage array 19 as a single topology, providing a virtual linkage for all the storage areas. This enables the entire client population to store and retrieve messages in the storage array 19.

In addition to recording the message transaction, the message tracking agent 18 replicates the message on one or more other storage servers or partitions in the storage array 19, a process referred to as mirroring. Mirroring can function in a background mode so that the mirroring occurs without specific instructions from the message tracking agent. Alternatively, the message handling system can integrate the function of disk or partition mirroring into the message tracking agent by looking, at step 160, at mirroring table 50 that maps each mail server to its corresponding mirror servers to add an additional attribute to the record in the tracking catalog 60 that specifies the mirrored location as the message is written to the mirrored location at step 162.

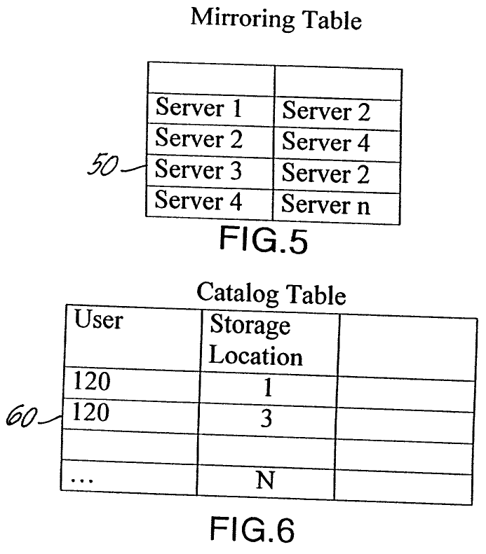

In contrast to standard email system storage approaches, the “mailbox” of the present invention is not tied to a particular server. It is this cataloging and array architecture that permits the system to overcome the message handling and storage capacity limitations of current solutions. For example, if the array is configured with several servers, the message can be stored at step 160 on server 1 and a corresponding mirror server (say server 2). The mirroring table is used to track the server mirroring (so that server 1 can be mirrored on a partition on server 2, server 2 can be mirrored on a partition on server 3, etc.). A simplified mirror table is shown in FIG. 5. The actual mirroring table would describe in more detail the disk partitions used, their locations, servers, disk names, and share names. For example, disk areas and records may be mirrored to multiple drives on different servers at different locations throughout the world. Mirroring enables the system to survive either singular or multiple critical points of failure. Should a server or component die, the whole machine can simply be swapped out and the array will continue functioning uninterrupted, because the mirroring table and message tracking agent will know where a duplicate copy of the message can be retrieved for as long as the primary storage location is being repaired and rebuilt. Additional servers can easily be added to the system without having to take the system offline.

The mirroring table 50 and tracking catalog table 60 contain the data required to support the retrieval of records by the message tracking agent 18 when an email client 10 wishes to retrieve its messages. These same tables can also be used to access the secondary storage locations to rebuild the original configuration of the records in the event of a failure.

As an example, consider an inbound message for jdoe@domain.com coming over the Internet 11 from a relay mail server. The relay server queries the DNS tables 13 and sees that the message has a client/recipient 10 recognized by the DNS 12 and indicates the appropriate SMTP listener to which it should be sent (e.g., server 1). The anti-virus check is performed, the SPAM filter is queried, and the optional SMS message feature is executed. The message is now stored on the primary local storage 25 of the server 1 and also on its mirror counterpart 26 (e.g., server 2), and the message tracking agent's 18 tracking catalog 60 is updated with the storage location of that particular message for later retrieval (the message is stored on server 1 and server 2).

As another example, consideration another message coming in for the same client 10. Since, in a preferred embodiment, the dynamic DNS 12 cycles through the available servers, the message can be stored on another server within the array. The message tracking agent 18 keeps track of where in the array 19 of SMTP listeners' storage devices each message is. For the sake of this example, assume the second message is now stored on server 3, and also on 3's mirror counterpart. The tracking catalog 60 is then updated again with the new entry.

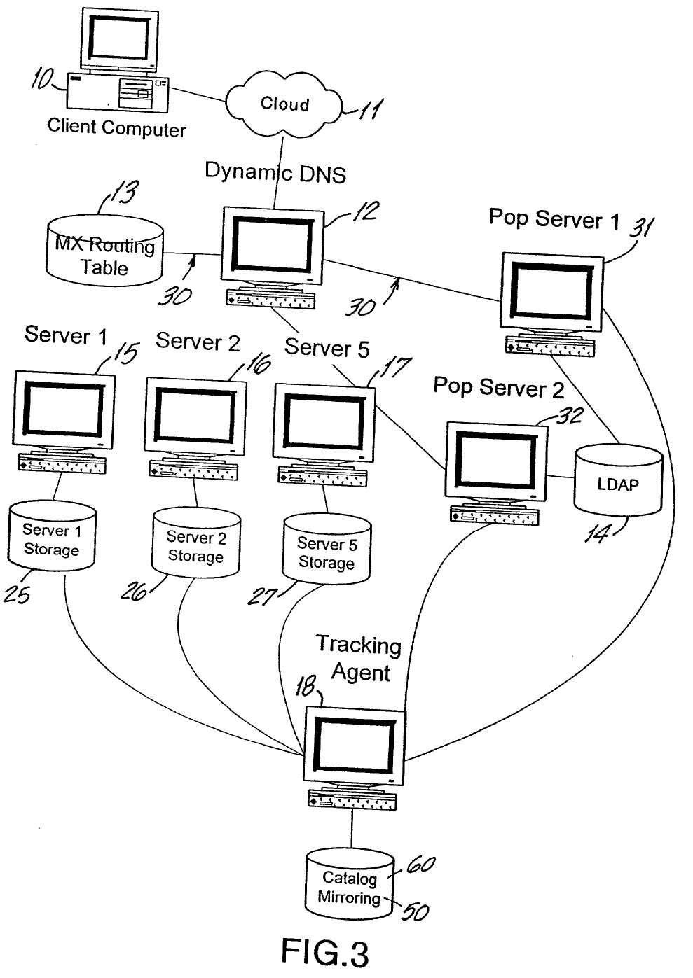

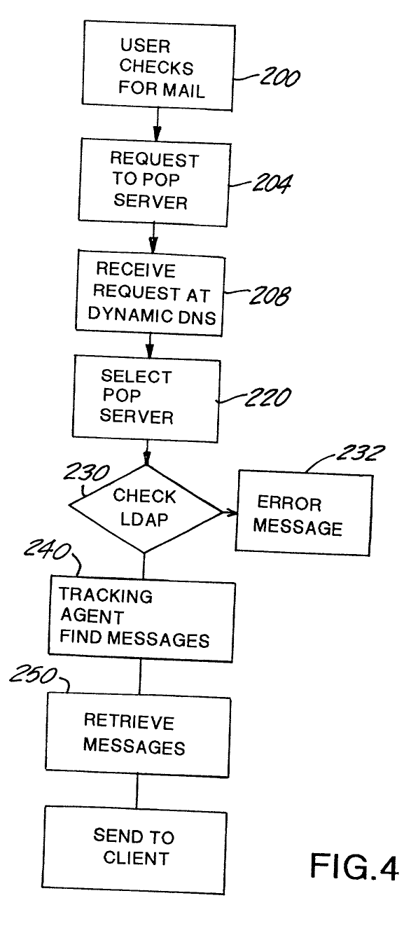

The mail retrieval process will now be described with regard to FIG. 3 and Flow diagram 4. Although two POP access servers 31, 32 are depicted in FIG. 3, the invention is not limited to this number of access servers, and any number of access servers is within the scope of the invention. For the purposes of this example, assume that the client computer 10 executes Microsoft Outlook, and that the client's 10 email software is configured to access a POP server for a particular mail server domain name. If the client 10 were communicating with the POP server through a dial up connection with an Internet Service Provider (ISP), the client would launch the mail application and click or select with their mouse the option on their display to send/receive mail at step 200. (This last step may be performed automatically depending upon the configuration of their mail client software.) The client application can generate at step 204 a request to the ISP for a connection to the POP server. The POP server name is processed like any other domain name request and is ultimately routed through the network to the dynamic DNS at step 208.

Upon receiving the mail request, the dynamic DNS 12 at step 220 connects to the next POP server queued to process the request. In the preferred embodiment, the POP servers are selected in the same manner as described for the selection of the SMTP servers for mail storage. In this manner, response time is immediate to process the request.

A check may be performed at step 230 to verify that the client 10 exists by checking the local mailbox database 14 to determine whether the client 10 connection references a valid email account. While this client information retrieval step would not necessarily refer the request to a particular email server, it would contain the verification information that authorizes the client to continue with the retrieval. If the client is not found, an error message can be generated and logged at step 232.

In a preferred embodiment, the message tracking agent 18 reads the tracking catalog table 60 directly at step 240 to determine where the client's 10 records were stored. The client messages are retrieved from the corresponding locations from storage array 19 at step 250 and compiled and sent to the client 10 at step 260. If no messages were found, notification can be sent back to the client computer 10 indicating that condition.

For example, a client 10 with the email address jdoe@domain.com launches his email program. Following the decision to check for mail, the client's computer 10 contacts the POP server indicated by his login parameters. Standard access validation is performed against mailbox database 14, the tracking catalog table 60 is queried to see where messages are stored for jdoe, and from the tracking catalog table 60 the message tracking agent 18 would know that jdoe's messages would be on server 1 and 3 (as demonstrated in our prior example of the storage process) and his messages are then retrieved and delivered.

Note that although the mail retrieval process was described in conjunction with a dial-up ISP connection using a POP server, the process is the same with any type of access server, such as a direct Internet connection using the Internet Messaging Access Protocol.

Of particular note is that the physical paths to the data stored on server 1 and server 3 are independent therefore the access time is much quicker.

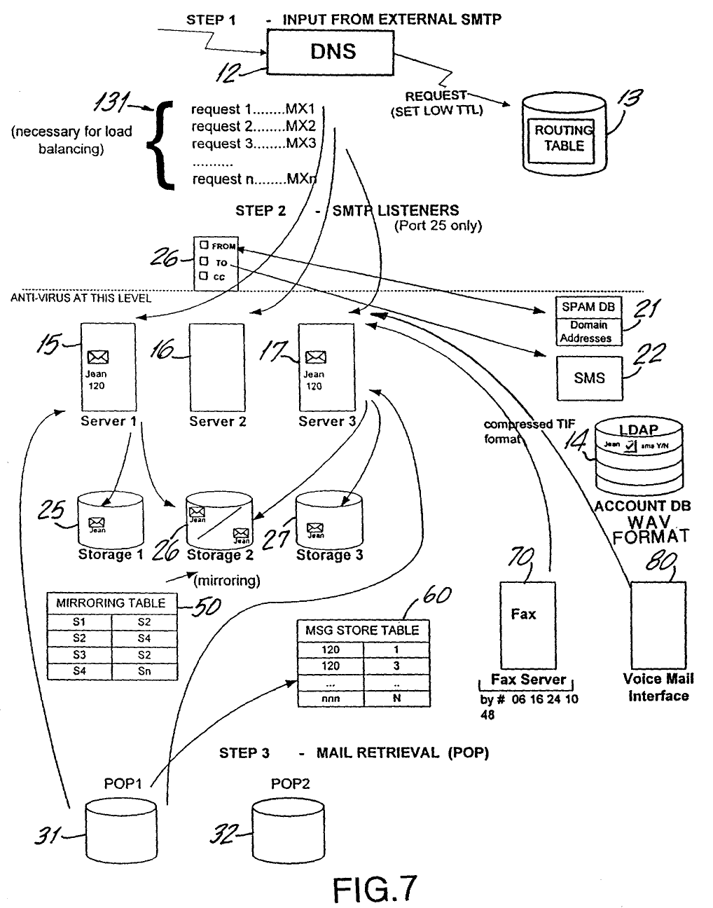

Referring now to FIG. 7, the system design also supports interfaces to other software products. For example, a fax server 70 could be configured to deliver inbound faxes to the client's mailbox in compressed tif format for retrieval via a simple mail retrieval process. Another example is a voice mail server 80 configured to deliver inbound voice mails to the client's mailbox in compressed wav format (via sound compression and format conversion technology) for retrieval via the same simple mail retrieval process. The system of the present invention can also process web mail and wireless application protocol (“WAP”) compliant messages.

The system of this invention is not limited to the embodiments disclosed herein. It will be immediately apparent to those skilled in the art that variations and modifications to the disclosed embodiment are possible without departing from the spirit and scope of the present invention. The invention is defined by the appended claims.

What is claimed is:

1. A clustered mail server system comprising:
a plurality of mail servers, each mail server connected to a plurality of storage servers;
at least one domain name server connected to each of the plurality of mail servers, to an external computer network, and to an internal computer network; and
a mirroring table that lists, for each of the plurality of mail servers, one or more other mail servers in the plurality of mail servers associated with each said mail server,
wherein the domain name server, upon receipt of a request from a sender mail server, selects one of said plurality of mail servers to which to route a message and routes the message to the selected mail server,
and wherein the selected mail server stores the message on a storage server accessible to said selected mail server, and on each of the at least one other storage servers associated with those mail servers listed in the mirroring table for said selected mail server.

2. The server system of claim 1, wherein the domain name server is adapted to select each of the plurality of mail servers in a roundtable manner as subsequent messages are received.

3. The server system of claim 1, wherein the domain name server is adapted to querying each of said plurality of mail servers as to load and based on the response to said query select one of said mail servers to process a mail request.

4. The server system of claim 1, further comprising a table of mail exchange records, such that each of the plurality of mail servers is associated with at least one mail exchange record, each said mail exchange record including a priority index for the associated mail server for determining the priority of selection of the associated mail server by the domain name server,
wherein the domain name server is adapted to altering the priority index in the mail exchange record associated with each mail server.

5. The server system of claim 1, further comprising:
a catalog table; and
a message tracking agent, wherein said message tracking agent creates a transaction record in the catalog table that records the storage servers on which a message is stored.

6. The server system of claim 5, further comprising
a plurality of access servers adapted to enable an client to retrieve messages stored on a first storage server connected to a first mail server and on each of the at least one other storage servers associated with mail servers listed in the mirroring table of said first mail server,
wherein the domain name server, upon receipt of a client's message retrieval request, selects one of said plurality of access servers to service the message retrieval request, and wherein the message tracking agent reads the catalog table to locate and compile the client's messages and returns said messages to the selected access server.

7. The server system of claim 1, further comprising a database of client addresses, so that the domain name server can verify the address of an incoming message received from the network, and can verify the address of a client requesting messages.

8. The server system of claim 1, further comprising:
means for detecting a virus attached to an incoming message;
a database of sender addresses, means for comparing a sender address of an incoming message against said sender address database, and means for blocking an incoming message whose sender address is in said sender address database; and
means to determine if an client wishes to be notified of an incoming message, and means to notify any such client of the incoming message.

9. The server system of claim 1, further comprising means for storing a facsimile message on a selected storage server associated with a mail server and on each of the at least one other storage servers associated with the mail servers listed in the mirroring table.

10. The server system of claim 1, further comprising means for storing a voicemail message on a selected storage server associated with a mail server and on each of the at least one other storage servers associated with the mail servers listed in the mirroring table.

11. The server system of claim 1, wherein each storage server associated with each of the plurality of mail servers is accessible by a physically independent path.

12. A system for load-balancing a plurality of interconnected mail servers and storage servers connected to a computer network via a domain name server, said system comprising:
one or more mail exchange records, wherein each mail exchange is associated with one of a plurality of mail servers and includes a priority index for the associated mail server;
means for a domain name server to change the value of the priority index for an associated server, said priority index indicative of the priority of said associated server for receiving email from the domain name server;
a mirroring table that lists, for each of the plurality of mail servers, one or more other mail servers in the plurality of mail servers associated with each said mail server;
a message tracking agent; and
a catalog table,
wherein the domain name server, upon receipt of a request from sender mail server, selects a first mail server with a priority index value indicative of a highest priority to process a message associated with the request, and
wherein the message tracking agent copies and stores said message to those storage servers associated with those mail servers listed in the mirroring table of the first mail server and records a record of the message and the storage servers on which said message is stored in the catalog table.

13. The system of claim 12, wherein said domain name server is adapted to querying each of said plurality of mail servers as to load and altering the value of the priority index in the mail exchange record associated with each mail server in response to said query.

14. The system of claim 12, wherein the domain name server is adapted to select each of the plurality of mail servers for storing incoming messages in a roundtable manner as subsequent messages are received.

15. The system of claim 12, further comprising
means for one of a plurality of access servers to retrieve messages stored on a first storage server associated with a first mail server and on each of the at least one other storage servers associated with mail servers listed in the mirroring table of said first mail server in response to a message retrieve request from a client,
wherein the domain name server, upon receipt of an client's message retrieval request, selects one of said plurality of access servers to service the message retrieval request, and
wherein the message tracking agent reads the catalog table to locate and compile the client's messages and returns said messages to the access server.

16. The system of claim 12, further comprising a database of addresses, so that the domain name server can verify the recipient address of an incoming request received from the network, and can verify the address of a client requesting messages.

17. The system of claim 12, further comprising:
means for detecting a virus attached to an incoming message;
a database of sender addresses, means for comparing a sender address of an incoming message against said sender address database, and means for blocking an incoming message whose sender address is in said sender address database; and
means to determine if a client wishes to be notified of an incoming message, and means to notify any such client of the incoming message.

18. The system of claim 12, further comprising means for storing an incoming facsimile message on a storage server associated with a selected mail server and on each of the storage servers associated with the at least one other mail servers listed in the mirroring table.

19. The system of claim 12, further comprising means for storing an incoming voicemail message on a storage server associated with a selected mail server and on each of the storage servers associated with the at least one other mail servers listed in the mirroring table.

20. The system of claim 12, further comprising a physically independent path to each storage server associated with each of the plurality of mail servers.

21. A method for processing messages comprising the steps of:
receiving, at a domain name server, a request from a sender server;
selecting, by the domain name server, one of a plurality of mail servers to which to rout an incoming message associated with said request;
routing the incoming message to the selected mail server;
storing the message on a storage server associated with said selected mail server;
copying said message to one or more other storage servers associated with mail servers from among the plurality of mail servers that are associated with said selected mail server; and
recording in a catalog table a record of the message and each of the storage servers wherein the message is stored.

22. The method of claim 21 further comprising the step of maintaining a mirroring table that associates with each mail server one or more other mail servers from among the plurality of mail servers.

23. The method of claim 21, further comprising the step of maintaining a priority index associated with each of the plurality of mail servers, wherein the value of the priority index is indicative of the priority of said associated mail server for receiving messages from the domain name server.

24. The method of claim 23, wherein the domain name server alters the value of a mail server's priority index in response to a query of said mail server's load.

25. The method of claim 23, wherein the domain name server alters the value of each mail server's priority index and selects each to service incoming messages on a roundtable basis.

26. The method of claim 21, further comprising the step of verifying that the recipient address of an incoming message corresponds to a valid account of the domain name server.

27. The method of claim 21, further comprising the steps of:
scanning the content of the incoming message in order to detect any virus attached to said message;
comparing the sender address of the incoming message against a sender address database, and blocking an incoming message whose sender address is in said sender address database; and
determining if an client wishes to be notified of an incoming message, and notifying any such client of the incoming message.

28. The method of claim 21, further comprising the steps of:
requesting, by an client, to retrieve stored messages;
selecting, by the domain name server, one of a plurality of access servers to process the client's retrieval request;
reading the catalog table to determine one or more storage servers and associated mail servers of said plurality of storage servers and mail servers on which the client's messages are stored;
compiling the client's messages from the one or more storage servers on which the client's messages are stored; and
sending the compiled messages to the client.

29. The method of claim 28., further comprising the step of verifying that the client requesting messages has a valid address on the domain name server.

30. The method of claim 28., further comprising the step of notifying the client if no messages were found.

31. The method of claim 21, wherein the messages are email messages.

32. The method of claim 21, wherein the messages are facsimile messages.

33. The method of claim 21, wherein the messages are voicemail messages.
